(19) United States
(12) Patent Application Publication
(10) Pub. No.: US 2016/0210491 A9
(43) Pub. Date: Jul. 21, 2016

(54) SYSTEMS AND METHODS FOR SECURE WIRELESS FINANCIAL TRANSACTIONS

(71) Applicants: Michael Rosenblatt, Campbell, CA (US); Gloria Lin, San Ramon, CA (US); Sean A. Mayo, Dover, NH (US); Taido L. Nakajima, Cupertino, CA (US)

(72) Inventors: Michael Rosenblatt, Campbell, CA (US); Gloria Lin, San Ramon, CA (US); Sean A. Mayo, Dover, NH (US); Taido L. Nakajima, Cupertino, CA (US)

(73) Assignee: APPLE INC., Cupertino, CA (US)

(21) Appl. No.: 13/251,097

(22) Filed: Sep. 30, 2011

Related U.S. Application Data
(63) Continuation of application No. 12/286,313, filed on Sep. 30, 2008.

(51) Int. Cl. G06Q 20/40; G06Q 20/32; G06F 17/00

(52) U.S. Cl. CPC G06K 7/1447; G06Q 20/3276

(57) ABSTRACT

There are provided systems and methods for conducting secure wireless financial transactions using portable electronic devices. For example, a method of conducting a wireless transaction is provided that includes taking a picture of a first QR code displayed on a transaction terminal using a camera of a portable electronic device. The method also includes sending data from the portable electronic device to the transaction terminal to conduct the financial transaction with the transaction terminal using a near field communication channel or another wireless communication channel, or both. This data is derived from the first QR code to enable the transaction terminal to verify that the portable electronic device is physically located near the transaction terminal.

### BACKGROUND

1. Technical Field

Embodiments of the present disclosure relate generally to handheld electronic devices and, more particularly, to wireless electronic devices configured to conduct financial transactions with transaction terminals.

2. Description of the Related Art

This section is intended to introduce the reader to various aspects of art that may be related to various aspects of the present disclosure, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Portable electronic devices such as cellular phones, media players and the like have become so fully integrated into popular culture that it is rare that people do not own and carry at least one with them. The portable electronic devices may be configured to perform functions beyond the conventional functions of media playback and cellular communications. For example, the portable electronic devices may be used to wirelessly transfer and receive documents and/or sensitive or personal information, such as the information to conduct a financial transaction. In such communications, as with any wireless transmission, the data being communicated is at risk of being intercepted. As such, the communication protocols used for wireless transmissions have built-in security features. However, when the data being communicated contains personal, financial, and/or generally sensitive data, additional security may be desirable.

### SUMMARY

Certain aspects of embodiments disclosed herein by way of example are summarized below. It should be understood that these aspects are presented merely to provide the reader with a brief summary of certain forms an invention disclosed and/or claimed herein might take and that these aspects are not intended to limit the scope of any invention disclosed and/or claimed herein. Indeed, any invention disclosed and/or claimed herein may encompass a variety of aspects that may not be set forth below.

The present disclosure generally relates to techniques for providing additional security for wireless communications using portable electronic devices. In accordance with some embodiments, a portable electronic device may be configured to utilize a short-range wireless communication device, such as a near field communication (NFC) interface, and at least one other module of the portable electronic device to help ensure the security of a transaction. The other module of the portable electronic device may include one or more of the following: a camera, a scanner, a global positioning system, an accelerometer, a touch screen, cellular communication system, or Wi-Fi system, among others.

The electronic device may include one or more communication interfaces for communicating with another device configured to communicate sensitive information, including financial information for a financial transaction, for example. Specifically, the electronic device may include interfaces for communicating over a wireless network, a personal area network, a near field communication channel, a Bluetooth channel, a cellular telephonic communication system, or the like, each of which may be useful in conducting such transactions.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects alone or in any combination. Again, the brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a front view of a portable electronic device in accordance with one embodiment;

FIG. 2 is a rear view of the portable electronic device of FIG. 1 in accordance with one embodiment;

FIG. 3 is a simplified block diagram of the device of FIGS. 1 and 2 in accordance with one embodiment;

FIG. 4 is a front view of screens of the device of FIG. 1 illustrating a method of initiating communications for a transaction in accordance with one embodiment;

FIGS. 5a-5b illustrate a transaction terminal for conducting transactions with the device of FIG. 1 in accordance with an embodiment;

FIG. 6 illustrates another transaction terminal for conducting transactions with the device of FIG. 1 in accordance with an embodiment;

FIG. 7 is a front view of screens of the device of FIG. 1 illustrating a method of conducting a financial transaction with the transaction terminal of FIG. 6 in accordance with an embodiment;

FIG. 8 illustrates a code provided by the screen of the transaction terminal of FIG. 6 in accordance with an embodiment;

FIGS. 9a-9d illustrate device authentication systems for conducting a transaction with terminal in accordance with embodiments;

FIG. 9e is a flow chart depicting a method for authentication of the device of FIG. 1 based on the location of the device and the location of a terminal in accordance with an embodiment;

FIG. 10 illustrates a screen of the device of FIG. 1 listing options for completing a transaction in accordance with an embodiment;

FIGS. 11-12 illustrate screens of the device of FIG. 1 for a user to enter a personal identification number (PIN) in accordance with embodiments;

FIG. 13 illustrates screens of the device of FIG. 1 for completing a purchase transaction with a merchant with device authentication in accordance with an embodiment;

FIGS. 14 and 15 illustrate screens of the device of FIG. 1 for completing a purchase transaction with a merchant with user authentication in accordance with embodiments;

FIG. 16 illustrates screens of the device of FIG. 1 for selecting and setting screen signature user authentication in accordance with embodiments;

FIG. 17 illustrates screen of the device of FIG. 1 for selecting and setting a gestural signature user authentication in accordance with embodiments;

FIGS. 18a-18d illustrate a user setting gestural signatures for user authentication in accordance with embodiments;

FIG. 19 illustrates screen of the device of FIG. 1 for selecting and setting voice signature user authentication in accordance with embodiments; and

FIG. 20 is a block flow diagram illustrating a file transfer transaction between two portable electronic devices in accordance with embodiments.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure is directed to techniques for providing security for wireless communications, including conducting a financial transaction, using a portable electronic device. The electronic device integrates several functionalities for such communications, including but not limited to, initiating communications, authenticating the portable electronic device and/or the user for a transaction, and completing the transaction. One or more input devices, such as a scanner, camera, keypad, near field communication (NFC) device, network device, or positioning device may be used to acquire information that may be used to authenticate the transaction. For example, a scanner or camera may be used to obtain information that may be fed back through an NFC communication channel to authenticate that the device is located at a particular location. Alternatively, a network device or positioning device may be used to authenticate the location of the device relative to a particular transaction terminal. These embodiments and others will be described in greater detail below.

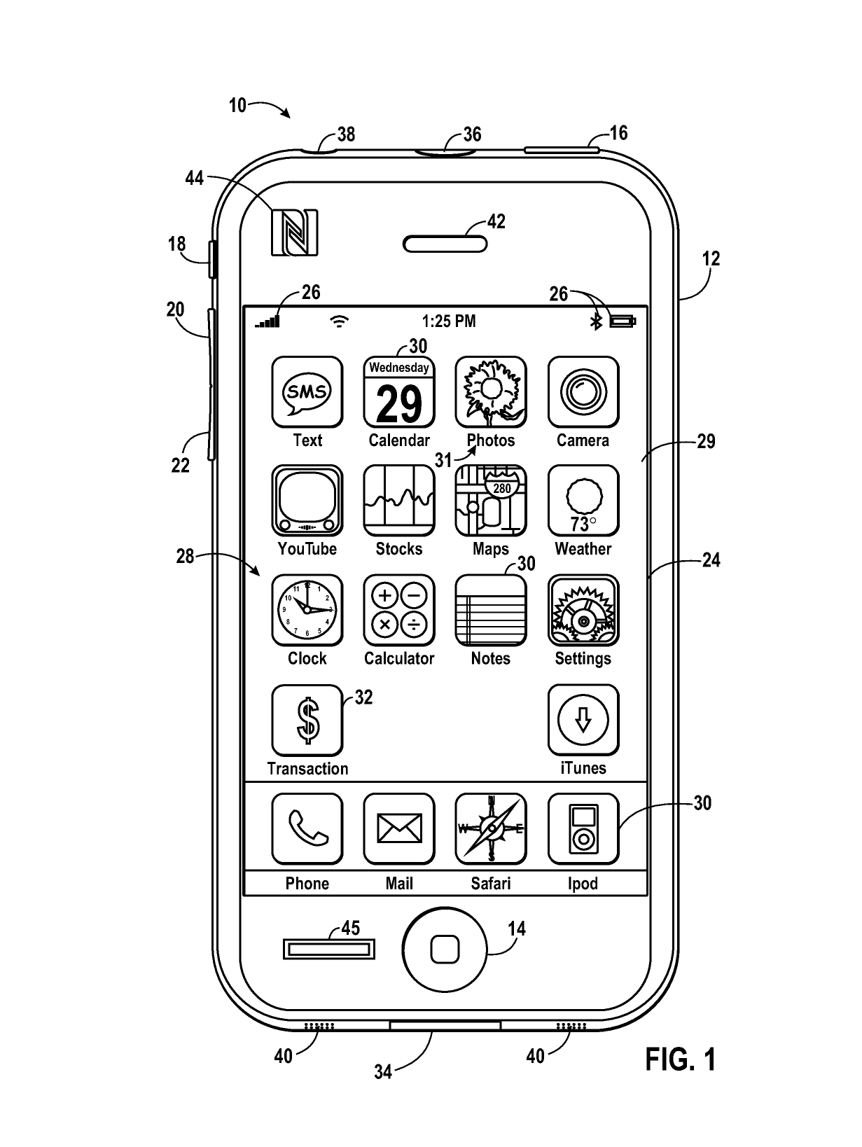

Turning to the drawings and referring initially to FIG. 1, a portable electronic device 10 is illustrated that may make use of the techniques for conducting a sales transaction described above. As illustrated, the electronic device 10 may be a handheld device incorporating the functionality of one or more portable devices, such as a media player, a cellular phone, a personal data organizer, and so forth. Depending, on the functionalities provided by the portable electronic device 10, a user may listen to music, play games, record video, take pictures, and place telephone calls, without being constrained by cords, cables or wires. Thus, a user may move freely with the device 10. In addition, the electronic device 10 may allow a user to connect to and communicate through the Internet or through other networks, such as local or wide area networks. For example, the electronic device 10 may allow a user to communicate using e-mail, text messaging, instant messaging, or other forms of electronic communication. The electronic device 10 also may communicate with other devices using short-range connections, such as Bluetooth and near field communication. By way of example, the electronic device 10 may be a model of an iPhone® available from Apple Inc. of Cupertino, Calif.

In the depicted embodiment, the device 10 includes an enclosure 12 that protects the interior components from physical damage and shields them from electromagnetic interference. The enclosure 12 may be formed from any suitable material such as plastic, metal, or a composite material and may allow certain frequencies of electromagnetic radiation to pass through to wireless communication circuitry within the device 10 to facilitate wireless communication.

The enclosure 12 allows access to user input structures 14, 16, 18, 20, and 22 through which a user may interface with the device. Each user input structure 14, 16, 18, 20, and 22 may be configured to control a device function when actuated. For example, the input structure 14 may include a button that when pressed causes a “home” screen or menu to be displayed on the device. The input structure 16 may include a button for toggling the device 10 between a sleep mode and a wake mode. The input structure 18 may include a two-position slider that silences a ringer for the cell phone application. The input structures 20 and 22 may include buttons for increasing and decreasing the volume output of the device 10. In general, the electronic device 10 may include any number of user input structures existing in various forms including buttons, switches, control pads, keys, knobs, scroll wheels, or other suitable forms.

The device 10 also includes a display 24 that may display various images generated by the device. For example, the display 24 may show photos of merchandise, advertisements, movies, and/or data, such as text documents, work schedules, financial spreadsheets, text messages, and email, among other things. The display 24 also may display system indicators 26 that provide feedback to a user, such as power status, signal strength, call status, external device connection, and the like. The display 24 may be any type of display such as a liquid crystal display (LCD), a light emitting diode (LED) display, an organic light emitting diode (OLED) display, or other suitable display. Additionally, the display 24 may include a touch-sensitive element, such as a touch screen.

The display 24 may be used to display a graphical user interface (GUI) 28 that allows a user to interact with the device. The GUI 28 may include various layers, windows, screens, templates, elements, or other components that may be displayed in all, or a portion, of the display 24. Generally, the GUI 28 may include graphical elements that represent applications and functions of the device 10. The graphical elements may include icons and other images representing buttons, sliders, menu bars, and the like. In certain embodiments, the user input structure 14 may be used to display a home screen 29 of the GUI 28. For example, in response to actuation of the input structure 14, the device may display graphical elements, shown here as icons 30, of the GUI 28. The icons 30 may correspond to various applications of the device 10 that may open upon selection of an icon 30. The icons 30 may be selected via a touch screen included in the display 24, or may be selected by user input structures, such as a wheel or button.

The icons 30 may represent various layers, windows, screens, templates, elements, or other components that may be displayed in some or all of the areas of the display 24 upon selection by the user. Furthermore, selection of an icon 30 may lead to a hierarchical navigation process, such that selection of an icon 30 leads to a screen that includes one or more additional icons or other GUI elements. Textual indicators 31 may be displayed on or near the icons 30 to facilitate user interpretation of each icon 30. It should be appreciated that the GUI 30 may include various components arranged in hierarchical and/or non-hierarchical structures.

When an icon 30 is selected, the device 10 may be configured to open an application associated with that icon and display a corresponding screen. For example, when the Transactions icon 32 is selected, the device 10 may be configured to open an application for conducting a financial transaction. The application may facilitate purchases or other financial transactions, such as those related to using an automatic teller machine (ATM). For each application, screens including additional icons or other GUI elements may be displayed on the display 24.

The electronic device 10 also may include various input and output (I/O) ports 34, 36, and 38 that allow connection of the device 10 to external devices. The I/O port 34 may be a connection port for transmitting and receiving data files, such as media files or customer order files. For example, the I/O port 34 may be a proprietary port from Apple Inc. In certain embodiments, the I/O port 34 may be used to connect an external scanning device, such as a barcode reader. The I/O port 36 may be a connection slot for receiving a subscriber identify module (SIM) card. The I/O port 38 may be a headphone jack for connecting audio headphones. In other embodiments, the device 10 may include any number of I/O ports configured to connect to a variety of external devices, including but not limited to a power source, a printer, a computer, and an intermediate device, such as a dock, for communicating with an external server. In certain embodiments, multiple ports may be included on the device 10. The ports may be any interface type, such as a universal serial bus (USB) port, serial connection port, Firewire port, IEEE-1394 port, or AC/DC power connection port.

The electronic device 10 may also include various audio input and output structures 40 and 42. For example, the audio input structures 40 may include one or more microphones for receiving voice data from a user. The audio output structures 42 may include one or more speakers for outputting audio data, such as data received by the device 10 over a cellular network. Together, the audio input and output structures 40 and 42 may operate to provide telephone functionality. Further, in some embodiments, the audio input structures 40 may include one or more integrated speakers serving as audio output structures for audio data stored on the device 10. For example, the integrated speakers may be used to play music stored in the device 10.

The device 10 may further include a near field communication (NFC) device 44. The NFC device 44 may be located within the enclosure 12, and a mark or symbol on the exterior of the enclosure 12 may identify its location within the enclosure 12. The NFC device 44 may allow for close range communication at relatively low data rates (424 kb/s), and may comply with standards such as ISO 18092 or ISO 21481, or it may allow for close range communication at relatively high data rates (560 Mbps), and may comply with the TransferJet® protocol. In certain embodiments, the communication may occur within a range of approximately 2 to 4 cm. The close range communication with the NFC device 44 may take place via magnetic field induction, allowing the NFC device 44 to communicate with other NFC devices or to retrieve information from tags having radio frequency identification (RFID) circuitry. As discussed below, the NFC device 44 may provide a manner of acquiring merchandise information, acquiring payment information, and communicating with an external server.

Information also may be acquired through a biometric sensor 45. The biometric sensor 45 may be located within the enclosure 12 and may be used to verify or identify a user. For example, the biometric sensor 45 may be used in conjunction with a smartcard to verify the identity of a consumer. In another example, the biometric sensor 45 may be used to identify a customer and obtain payment information for that customer by accessing a database of stored customer information. The database may be maintained by the merchant or by a third party service provider. The biometric sensor 45 may include a fingerprint reader or other feature recognition device and may operate in conjunction with a feature processing program stored on the electronic device 10.

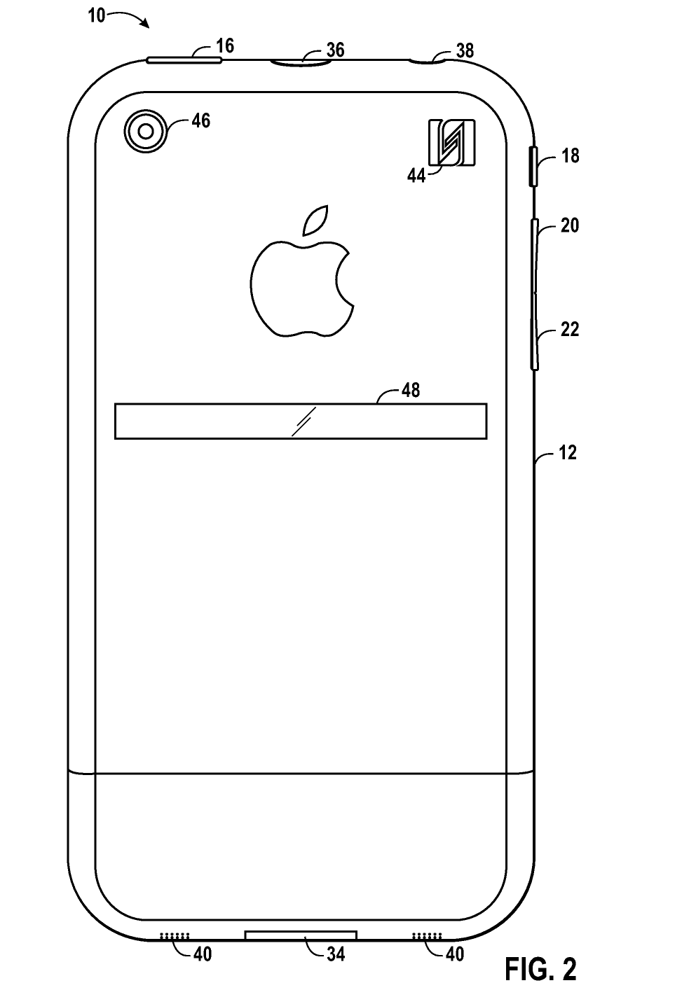

FIG. 2 illustrates the back of the electronic device 10. Two additional input devices may be accessed from the back of the device 10, a camera 46 and a scanner 48. Of course, the locations of the camera 46 and the scanner 48 are provided for illustrative purposes. In other embodiments, the camera 46 and scanner 48 may be accessed from the front or side of the device 10.

The camera 46 may be used to capture images or video and may be used to obtain merchandise information or payment information. For example, the camera 46 may be used to capture an image of a credit card to obtain payment information. In another example, the camera 46 may be used to take a picture of an item for purchase to identify the item. The camera 46 may be a 2.0 megapixel camera or other suitable camera and may operate in conjunction with image processing software stored within the electronic device 10.

The scanner 48 may be located within the enclosure 12 and may be used to obtain merchandise information and/or payment information. For example, the scanner 48 may be used to read a stock-keeping unit (SKU) number of an article for purchase. In another example, the scanner 48 may be used to read bank account information from a check. The scanner 48 may be a laser scanner, LED scanner, or other suitable scanning device and may operate in conjunction with a decoder stored within the electronic device 10.

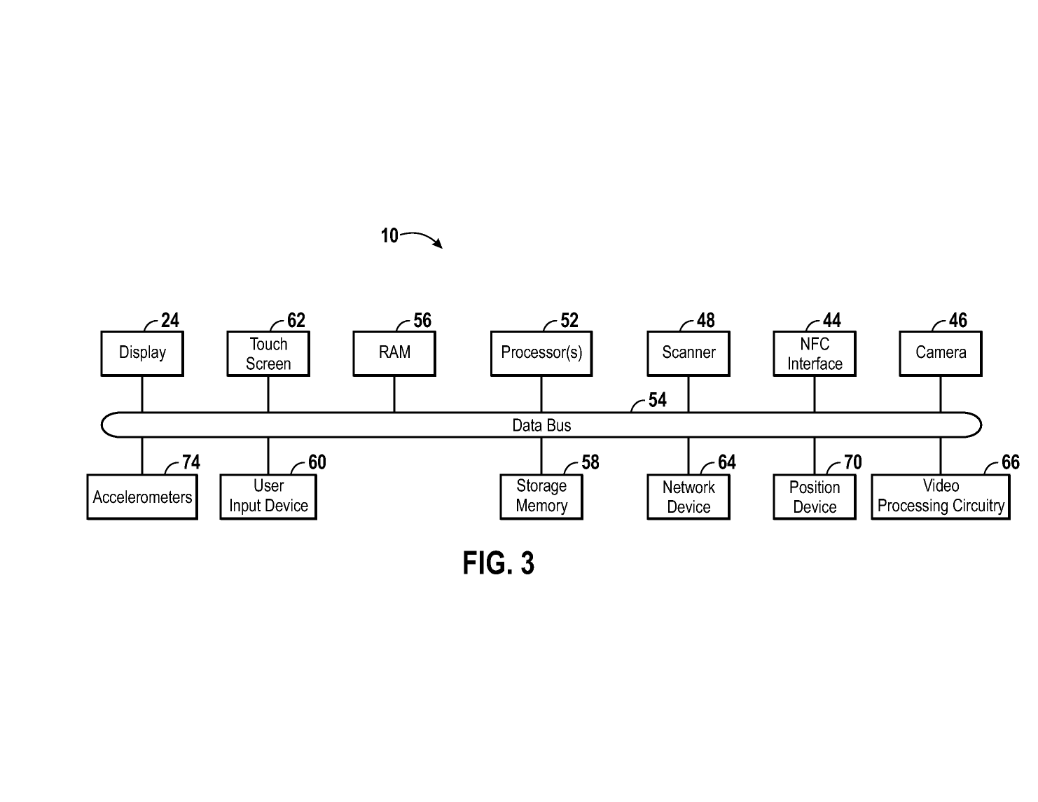

Additional details of the illustrative device 10 may be better understood by reference to FIG. 3, which is a block diagram illustrating various components and features of the device 10 in accordance with one embodiment of the present invention. As stated above, the device 10 may include a scanner 48, a camera 46, and an NFC interface 44. The operation of the device 10 may be controlled by one or more processor(s) 52 that provide the processing capability required to execute the operating system, programs, graphical user interface 28, and any other functions of the device 10. The processor(s) 52 may include a single processor or a plurality of processors. For example, the processor(s) 52 may include “general purpose” microprocessors, a combination of general and special purpose microprocessors, instruction set processors, graphics processors, video processors, and/or related chips sets, and/or special purpose microprocessors. The processor(s) 52 also may include on board memory for caching purposes.

The processor(s) 52 may be coupled to a data bus 54 and configured to transmit PIO instructions to the various devices coupled to the data bus 54 or to initiate DMA transfers. As such, the data bus 54 may facilitate both DMA transfers and direct read and write instructions from the processor(s) 52. In embodiments, the data bus 54 may be an Advanced Microcontroller Bus Architecture (AMBA) compliant data bus.

The electronic device 10 may also include a random access memory (RAM) 56 electrically coupled to data bus 54. The RAM 56 may include any type of RAM, such as dynamic RAM and/or synchronous double data rate RAM, for example, and may also include non-volatile memory devices, such as ROM, EPROM and EEPROM or some combination of volatile and non-volatile memory. Additionally, the RAM 56 may also include a memory controller that controls the flow of data to and from the RAM 56.

Information used by the processor(s) 52 may be located within storage memory 58. The storage memory 58 of electronic device 10 may be used for storing data required for the operation of the processor(s) 52 as well as other data required by the device 10. For example, the storage memory 58 may store the firmware for the electronic device 10 usable by the processor(s) 52, such as an operating system, other programs that enable various functions of the electronic device 10, GUI functions, and/or processor functions. The storage memory 58 also may store components for the GUI 28, such as graphical elements 30, screens, and templates. Additionally, the storage memory 58 may store data files such as media (e.g., music and video files), image data, software, preference information (e.g., media playback preferences or payment option preferences, as discussed below), wireless connection information (e.g., information that may enable the device 10 to establish a wireless connection, such as a telephone connection), subscription information (e.g., information that maintains a record of podcasts, television shows or other media to which a user subscribes), telephone information (e.g., telephone numbers), and any other suitable data. The storage memory 58 may be non-volatile memory such as read only memory, flash memory, a hard drive, or any other suitable optical, magnetic, or solid-state computer readable media, as well as a combination thereof.

A user may navigate through the GUI 28 (FIG. 1) using user input devices 60 coupled to input structures located at external surfaces of the device 10. The user input devices 60 may interface with the input structures 14, 16, 18, 20, and 22 shown in FIG. 1 and may communicate with the processor(s) 52 through an I/O controller (not shown.)

As noted above, a user may also control the device 10 by touching the graphical elements within the GUI 28. As such, a touch screen 62 may be positioned in front of or behind the display 24 and may be used to select graphical elements 30 shown on the display 24. The touch screen 62 is configured to receive input from a user's or object's touch and to send the information to the processor(s) 52, which interprets the touch event and performs a corresponding action. The touch screen 62 may employ any suitable type of touch screen technology such as resistive, capacitive, infrared, surface acoustic wave, electromagnetic, or near field imaging, and may be used in conjunction with or independently of the user input device 60 to select inputs for the device 10.

The device 10 may also include one or more network devices 64 for receiving and transmitting information over one or more broadband communications channels. As such, the network device 64 may include one or more network interface cards (NIC) or a network controller. In some embodiments, the network device 64 may include a local area network (LAN) interface for connecting to a wired Ethernet-based network and/or a wireless LAN, such as an IEEE 802.11x wireless network. In certain embodiments, the NFC interface 44 may be used to receive information, such as the service set identifier (SSID), channel, and encryption key, used to connect to the LAN.

The network device 64 also may include a wide area network (WAN) interface that permits connection to the Internet via a cellular communications network, such as an Enhanced Data rates for GMS Evolution (EDGE) network, or a Universal Mobile Telecommunications System (UMTS) network. Further, the network device 64 may include a personal area network (PAN) interface for connecting to a PAN such as a Bluetooth® network, an IEE 802.15.4 (ZigBee) network, or an ultra wideband (UWB) network. The network device 64 may interact with an antenna to transmit and receive radio frequency signals of the network. The network device 64 may include any number and combination of network interfaces. Among other things, the network device 64 may allow the device 10 to send and receive a broad range of shopping related information, as will be described below.

The device 10 may also include video processing circuitry 66 coupled to the data bus 54. The video processing circuitry 66 may be configured to process video data, such as images received from camera 48, and send the processed video data to other parts of the system. For example, the video processing circuitry 66 may be configured to compress video data obtained from camera 48 into a JPEG or MPEG format and send the compressed video data to RAM 56 or storage memory 58. For another example, the video processing circuitry 66 may be configured to send uncompressed or decompressed video data to the RAM 56 or the display 24. For yet another example, the video processing circuitry may be used to extract textual or encoded information from an image, such as numbers, letters, and/or bar code information.

The device 10 may also include a positioning device 70 used to determine a user's geographical position. The positioning device 70 may provide information such as longitude and latitude of the device as well as the devices position relative to landmarks including streets and buildings. As such, the positioning device may indicate positioning on a map, such as a street map or building map, for example. The positioning device 70 may utilize the global positioning system (GPS) implemented using satellite communications or a regional or site-wide positioning system that uses cell tower positioning technology or Wi-Fi technology, for example.

Accelerometers 74 may also be provided with the device 10. The accelerometers 74 may include multi-axis accelerometers such as three-axis accelerometers, for example, so that the movement of the device 10 in any direction can be determined. As will be discussed in detail below, the detection of the movement of the device may be used for authenticating a user in accordance with some embodiments.

The portability of the device 10 makes it particularly well suited to performing transactions such as automatic teller machine (ATM) transactions, and purchase transactions. In conducting such transactions, the device 10 may be used to transfer sensitive data including credit/debit card information, bank account information, personal identification numbers (PINs), passwords and other personal information. Additionally, the device 10 may be useful for transferring other sensitive information and documents. As such, providing for the security of the transmissions channel is of paramount importance.

Standard security features of the device 10 may include one or more cryptographic protocols, such as a secure sockets layer (SSL) protocol or a transport layer security (TLS) protocol, for establishing secure communications between the device 10 and another device. The security features may be particularly useful when transmitting payment information, such as credit card information or bank account information. The security features also may include a secure storage area that may have restricted access. For example, a PIN or other verification data may need to be provided to access the secure storage area. In certain embodiments, preferences may be stored within the secure storage area. Further, security information, such as an authentication key, for communicating with a retail server may be stored within the secure storage area. In certain embodiments, the secure storage area may include a microcontroller embedded within the electronic device 10.

Embodiments disclosed herein may provide additional robustness to the security features listed above. In particular, the embodiments disclosed herein are directed toward increasing the security provided by standard communication modes by providing duplicative and/or redundant security using one or more additional devices, as will be discussed in detail below. To facilitate an understanding of the operation of the device 10 in this context and the systems that are used to provide security, the following discussion refers to figures depicting a GUI that may be displayed on the screen 24.

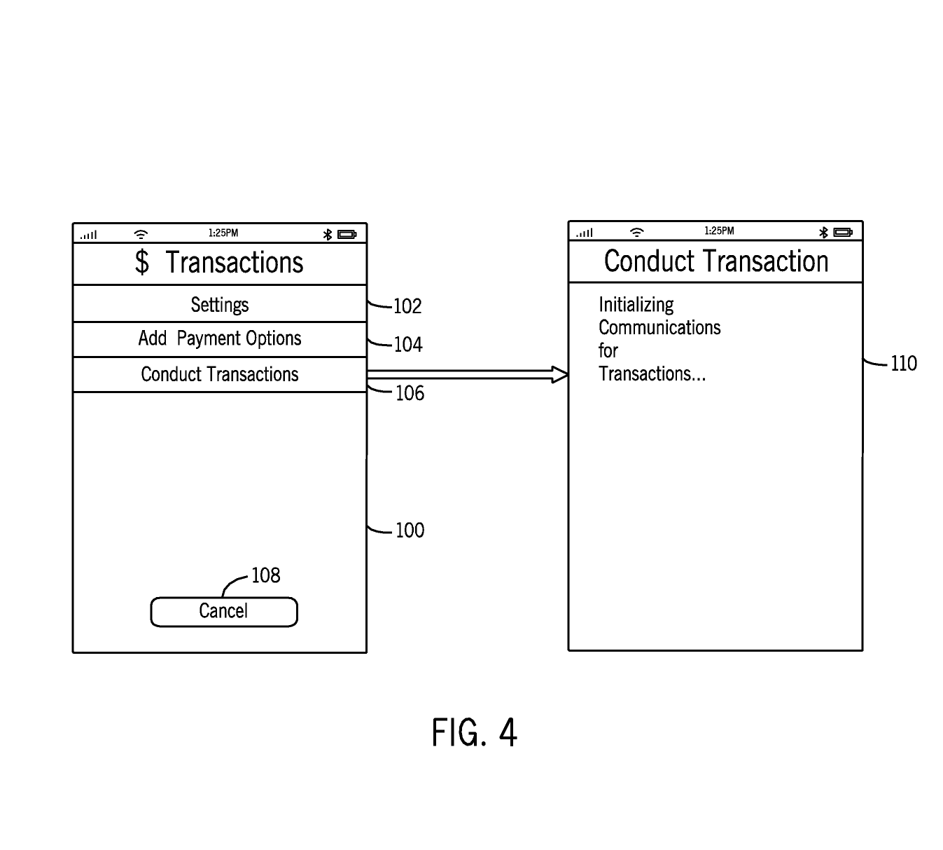

As discussed above, the various icons of the GUI displayed on screen 24 in FIG. 1 may provide access to applications, programs, and/or functions of the device 10. As such, upon selection of an icon, the device 10 may open an application and display a new screen that displays data related the selected application. For example, upon selection of the transaction button 32, a user may be brought to a transaction home screen 100, shown in FIG. 4, which may include a variety of options for a transactions application that a user may select. Specifically the transaction home screen 100 may allow for a user to modify the settings for transactions using the settings button 102, add payment options for financial transactions using the add payment options button 104 or conduct transactions by selecting the conduct transaction button 106. Additionally, a user may select a cancel button 108 which may be configured to re-direct the user back to the home screen 29. The selection of the settings button 102 and the add payment options button 104 will be discussed in greater detail below. However, upon selection of the conduct transactions button 106, a user may be brought to a conduct transaction screen 110.

The conduct transaction screen 110 may indicate that the device 10 is attempting to initiate communications for transactions. During this time, the device 10 may be attempting to communicate via wireless communications with another transaction terminal, another portable electronic device or wireless enabled device. For example, the device may be attempting to initiate near field communications, Wi-Fi communications, or broadband communications with a terminal.

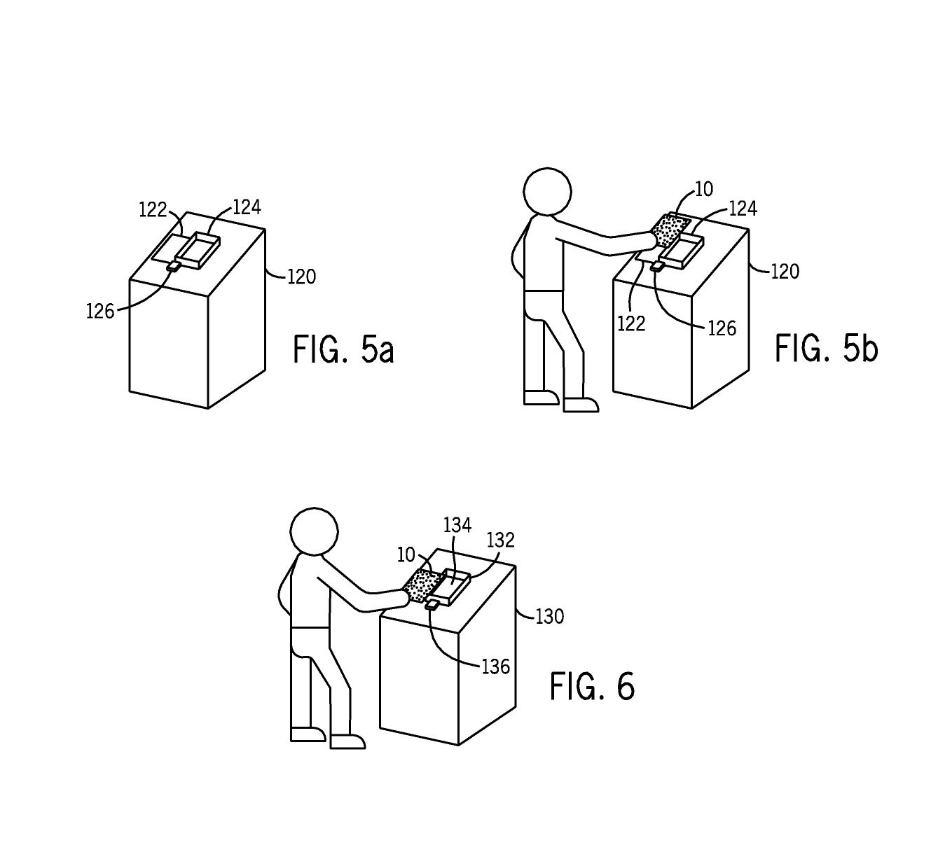

FIG. 5A illustrates a transaction terminal 120 that may include a screen 122 in accordance with some embodiments. The screen 122 may be configured to communicate information to a user via a GUI that contains text, images and icons. Additionally, the transaction terminal 120 may include a box structure 124 over a portion of the screen 122. As shown in FIG. 5B, a user may position the device 10 over the box 124 to obscure the portion of the screen 122 inside the box 124. As will be discussed in great detail below, this may provide additional security for transactions between the device 10 and the terminal 120.

The device 10 may be configured to communicate with the transaction terminal 120 using a short range wireless communication protocol, when positioned over the box 124. As such, the terminal 120 may include a wireless communication device 126. The wireless communication device 126 may be approximately located near the box 124 and/or the screen 122. As such, the transaction terminal 120 may be enabled to communicate via a wireless communication means with the device 10. In some embodiments, the wireless communication device 126 may be a near field communication (NFC) device and the device 10 may be configured to initiate NFC communications with the terminal 120.

To conduct a transaction between the device 10 and the terminal 120, a user may use buttons (not shown) located on the transaction terminal 120. In some embodiments, the screen 122 may be a touch screen such that the user may communicate with the transaction terminal using the screen 122. In other embodiments the device 10 may be used exclusively as a user input device for transactions between a terminal 120 and the device 10.

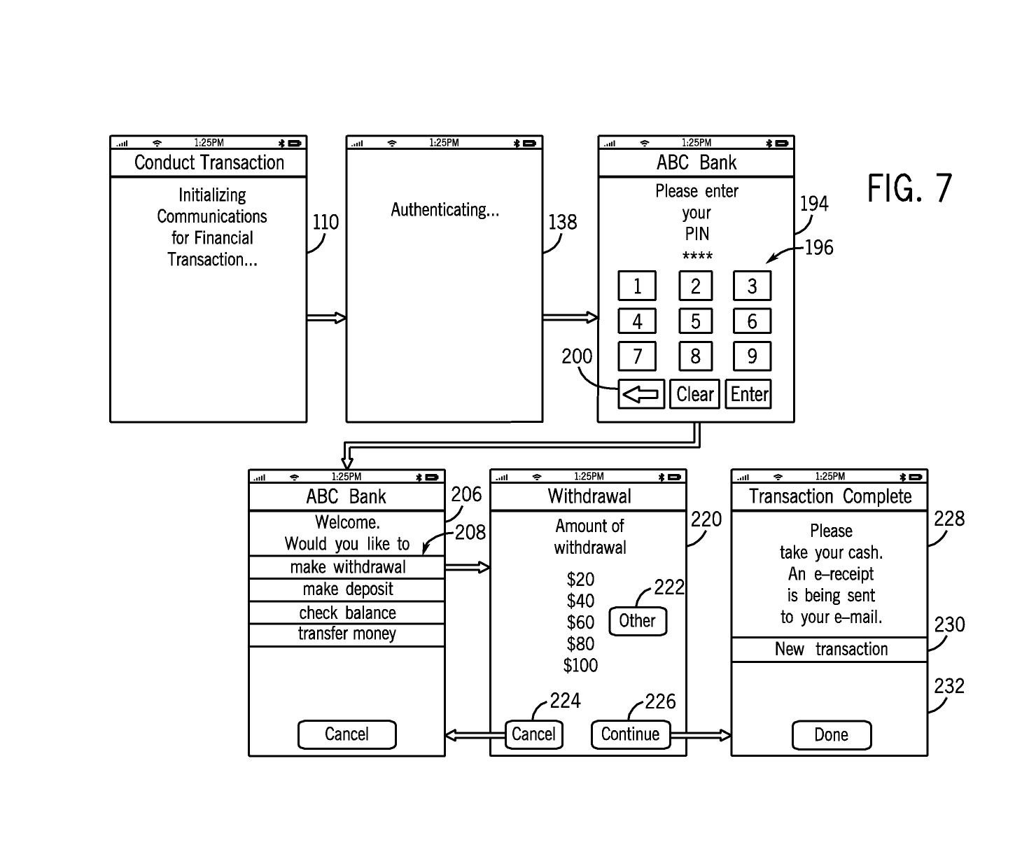

As shown in FIG. 6, a transaction terminal 130 may include a box 132 and a screen 134 which may be obscured from view when a device 10 is placed over the box 132. Because the device 10 may obscure the screen 134, the device 10 may be configured to display information from the terminal 130 and may allow for a user to communicate with the terminal 130. Similar to the terminal 120, a wireless communication device 136 may be located proximate to the box 132 to allow for wireless communication between the device 10 and the transaction terminal 130. The proximate location of the wireless communication device 136 to the box 132 may allow for the device 10 and the transaction terminal 130 to communicate via an NFC communications when the device 10 is positioned over the box 132.

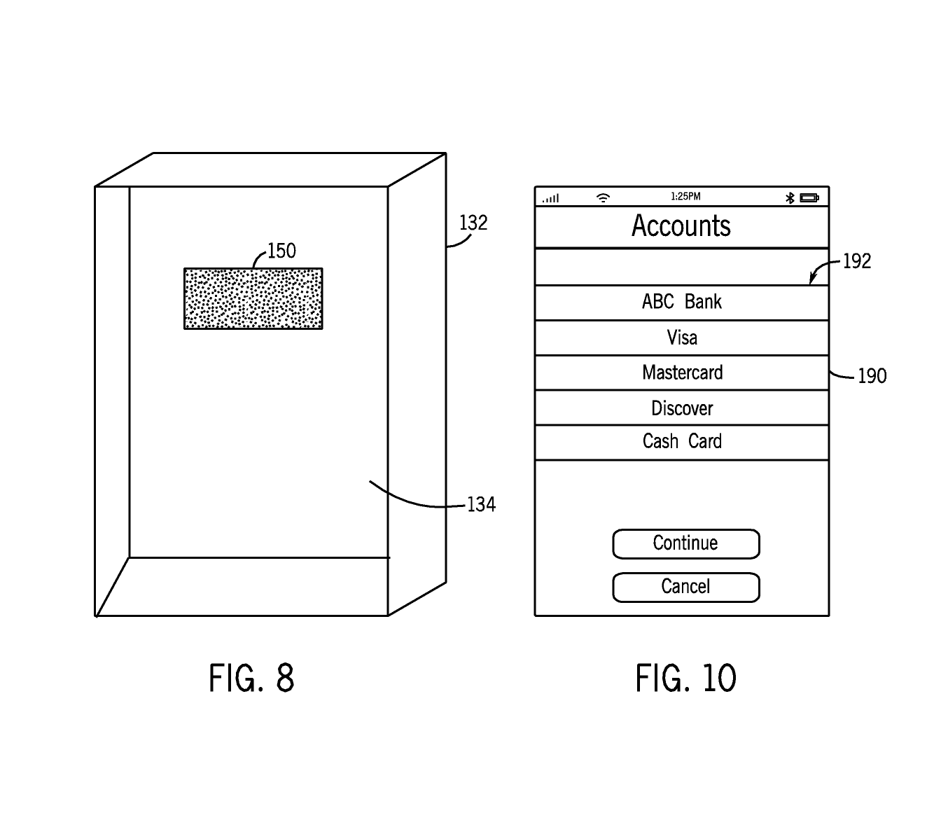

Referring now to FIG. 7, once the device 10 has initiated communications for transactions with the transaction terminal 130, the device 10 may be configured to authenticate itself in order to complete a transaction. During the authentication process, the device 10 may be configured to display an authenticating screen 138. The authentication process may include a variety of alternative processes. For example, in accordance with some embodiments, the device 10 may be authenticated by providing a code that it can only read by being placed over the box 134.

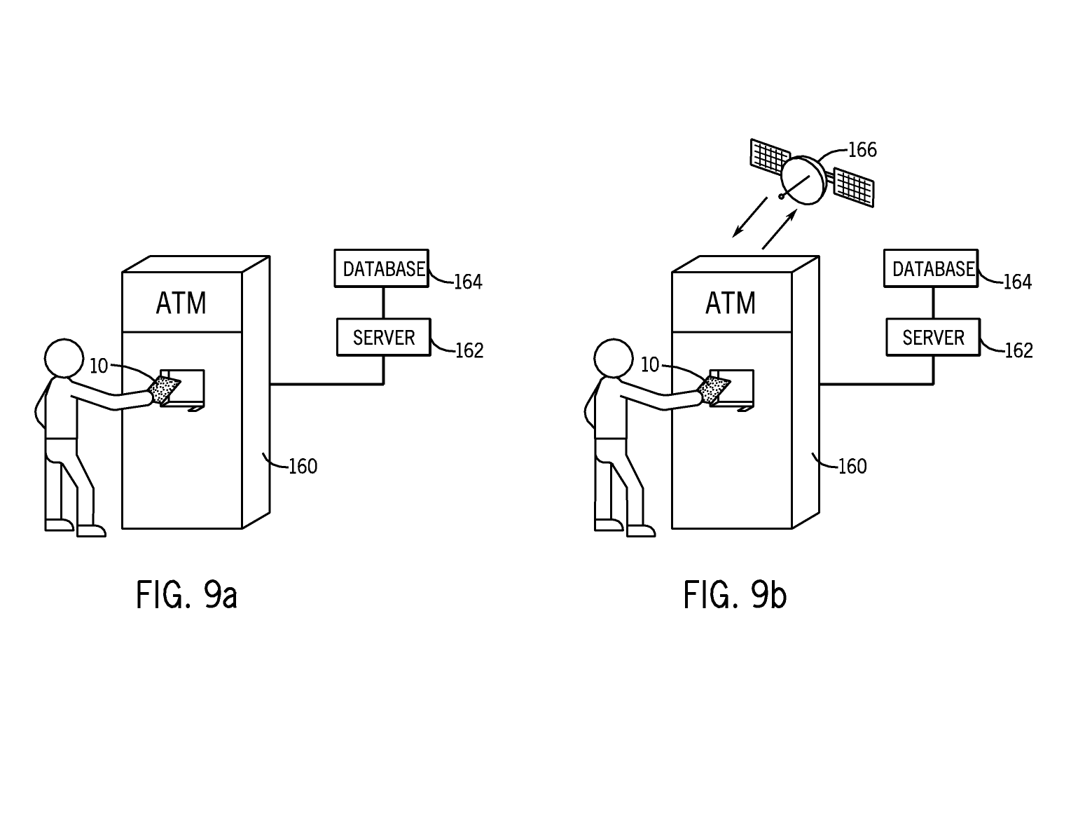

Specifically, in some embodiments, the transaction terminal 132 may be configured to display a code on the screen 134 within the box 132. For example, as illustrated in FIG. 8, the screen 134 may display a code such a QR code, a bar code, a micro QR code, etc. that can only be read and/or obtained by the device 10. Specifically, the device 10 may be configured to read the code 150 by taking a picture of the code 150 using the camera 46 or by scanning the code 150 using the scanner 48, for example. The device 10 may then decode the information and provide the decoded information back to the terminal 130 via the wireless communication device 136. If the device 10 provides the decoded information back to the terminal 130, the device 10 is authenticated.

In some embodiments, information decoded from the code 150 may be fed back to the terminal only once to authenticate. In some other embodiments, the decoded information be continuously fed back tot eh terminal to maintain authentication. For example, the code 150 may be a continuously changing code or may be dynamic code. Specifically, the terminal 130 may be configured to generate and provide new codes periodically or at randomly spaced intervals for continuous authentication of the device 10. The device 10 may be configured to continuously read a code 150 and feed it back to the wireless device 136 during the transaction to authenticate that the device 10 is actually located at the transaction terminal 130. The box 132, as discussed above, prevents eaves droppers, or others who are trying to obtain sensitive data from reading the screen inside the box 132. Thus, only the device 10 can read the code 150 and provide the decoded information back to the transaction terminal 130 to authenticate the device 10 as conducting a transaction with the transaction terminal 130.

In some embodiments, the code 150 may include an encryption code or key. For example, the code 150 may include a public key of a public/private encryption key scheme. The public key may be used to encrypt communications from the device 10 to the transaction terminal 130. In yet other embodiments, the code 150 may include both an encryption key and an encoded information portion. Furthermore, the encoded information portion may be dynamic. Thus, the device 10 may be configured to decode the code 150 and use the encryption key of the code 150 to encode information, including the dynamic decoded information, to be sent to the terminal 130.

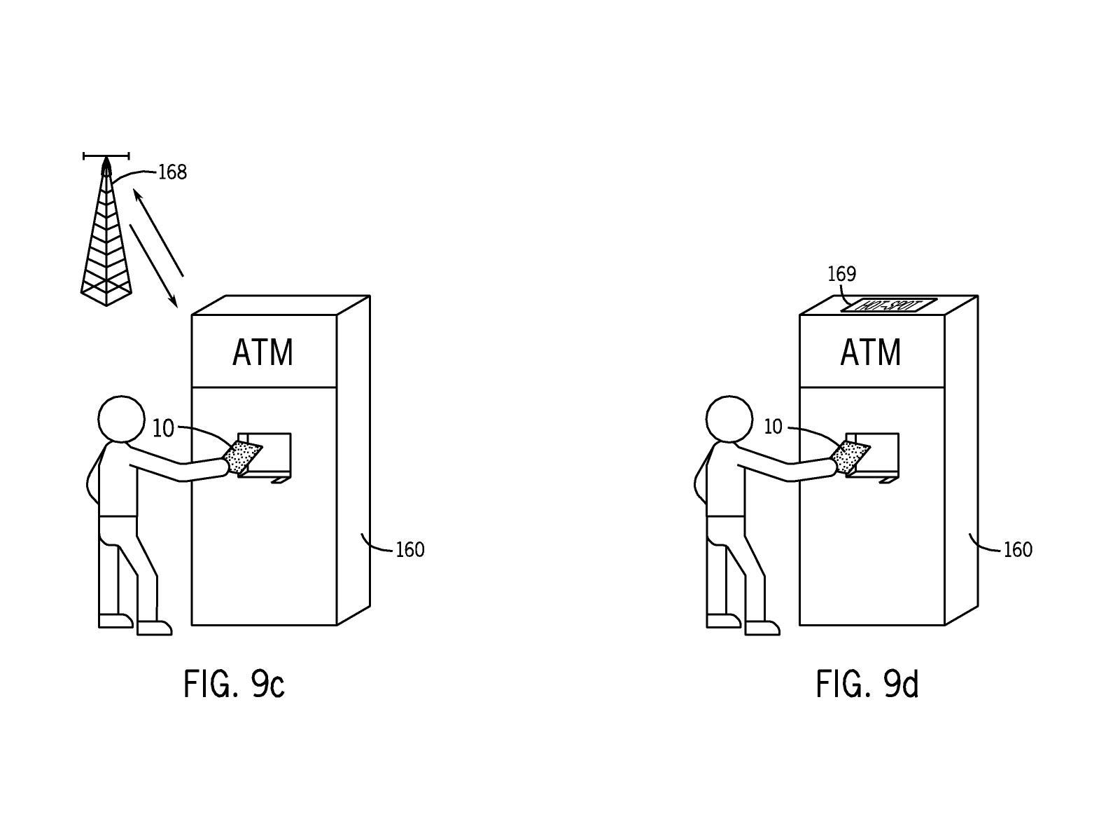

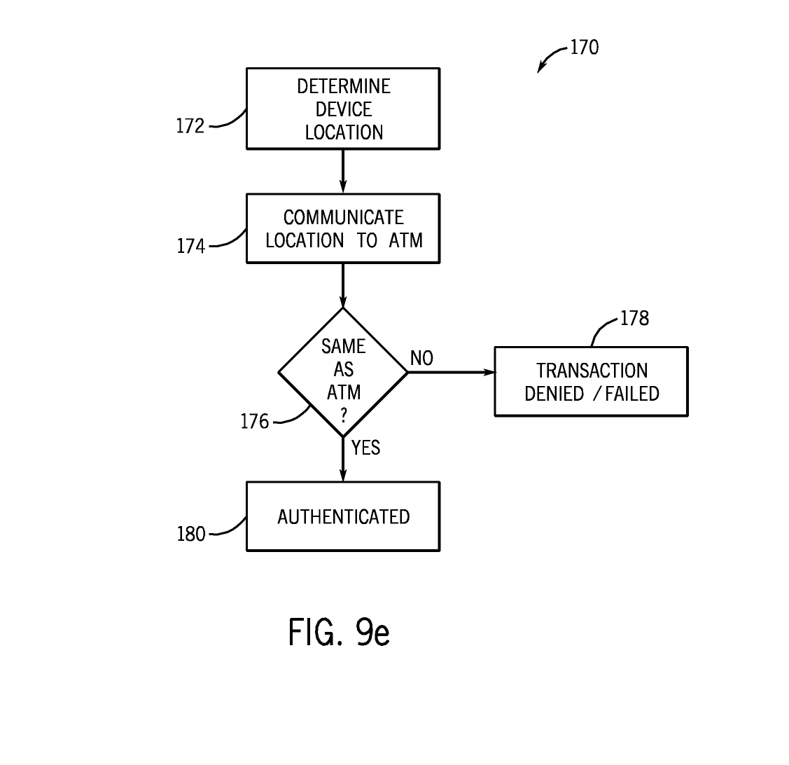

Alternative authentication schemes may also be employed. Specifically, for example, as illustrated in FIG. 9A, a transaction terminal, such as an automatic teller machine (ATM) 160 may be coupled to a server 162 which may be configured to authenticate the device 10 for transactions. In particular, the server 162 may be coupled to a database 164 that stores data related to a user or the device 10. In some embodiments, the information stored on the database 164 may include information related to a machine identifier which may be associated with the hardware of the device 10 or may be generated by software. In alternative embodiments, the database 164 may store data related to devices (not shown) which may have previously been coupled to the device 10 via a USB port or other port. For example, the database may store identifying information about a home computer or other devices with which the device 10 may have been coupled. In yet other alternative embodiments, the database 164 may store information related to addresses and/or phone numbers or names from a contacts list stored on the device 10. The server 162 may be configured to retrieve identifying information from the device 10 and compare it with the data stored in the database 164.

As illustrated in FIGS. 9b-9d, authentication may be based on the location of the device 10 in some embodiments. FIG. 9B illustrates the location of the device 10 being determined based on information from the positioning device 70 (FIG. 3). For example, the device 10 may communicate with a satellite 166 to determine the location of the device 10. The ATM 160 may have hardware identifier and/or software identifier information that may be used to identify the location of the ATM 160. For example, the server 162 may be configured to determine the location of the ATM 160 based on information stored on the database 164. The server 162 may then confirm that the location of the device 10 coincides with the location of the ATM 160. As such, the device 10 may be authenticated based on the location of the device 10 as determined by the positioning system 70.

In other embodiments, the ATM 160 may authenticate the device 10 based on location determined by communications with a cell tower or cellular network 168 as shown in FIG. 9C. The process will be similar to that of the location determination or authentication of FIG. 9B, but the location of device 10 is determined based on communications with the cellular network 168, rather than on communication with a satellite.

In yet other embodiments, the location of the device 10 may be determined based on the communications with a wireless hot spot, such as a Bluetooth or Wi-Fi hot spot. For example, a hot spot 169 may be located near the ATM 160, as illustrated in FIG. 9B. The Bluetooth and Wi-Fi communication protocols have a known communication distance. That is it is generally known the distance they are able to communicate. In accordance with the present embodiments, the transmission distance or communication distance provided by the hot spot 169 may be hindered or limited to an area immediately around the ATM 160. For example, the hot spot 169 may only communicate within a distance of fifteen feet, for example. While hot spots generally may generally provide access to a network, such as a local area network, a wide area network, or the Internet, the hot spot 169 may be configured to simply communicate a service flow identifier (SFID) or other identifying information to the device 10. The identifying information may be a dynamic and may be known by the ATM 160. The may be used by the device 10 to indicate that the device is located within communication range of the hot spot 169. Thus, upon receiving the identifying information, the device 10 may communicate the identifying information to the ATM 160 to indicate that the device 10 is actually located at the ATM 160 and the device 10 may be authenticated.

FIG. 9E illustrates a flow chart 170 that generally shows the authentication process based upon location of the device 10. The flow chart 170 begins by determining the device location as indicated at block 172. As discussed above, a variety of modes are provided to determine the location of the device. In some embodiments, one or more location identifying modes may be implemented. Once the device location has been determined, the device location information may be communicated to a transaction terminal, such as the ATM 160, as indicated in block 174. A decision is made, as indicated at block 176, as to whether or not the location of the device 10 corresponds with the location of the ATM 160. If not, the transaction may be terminated, as indicated at block 178. Alternatively, if the locations correspond, the device 10 is authenticated, as indicated at block 180, and the device may conduct transactions with the terminal.

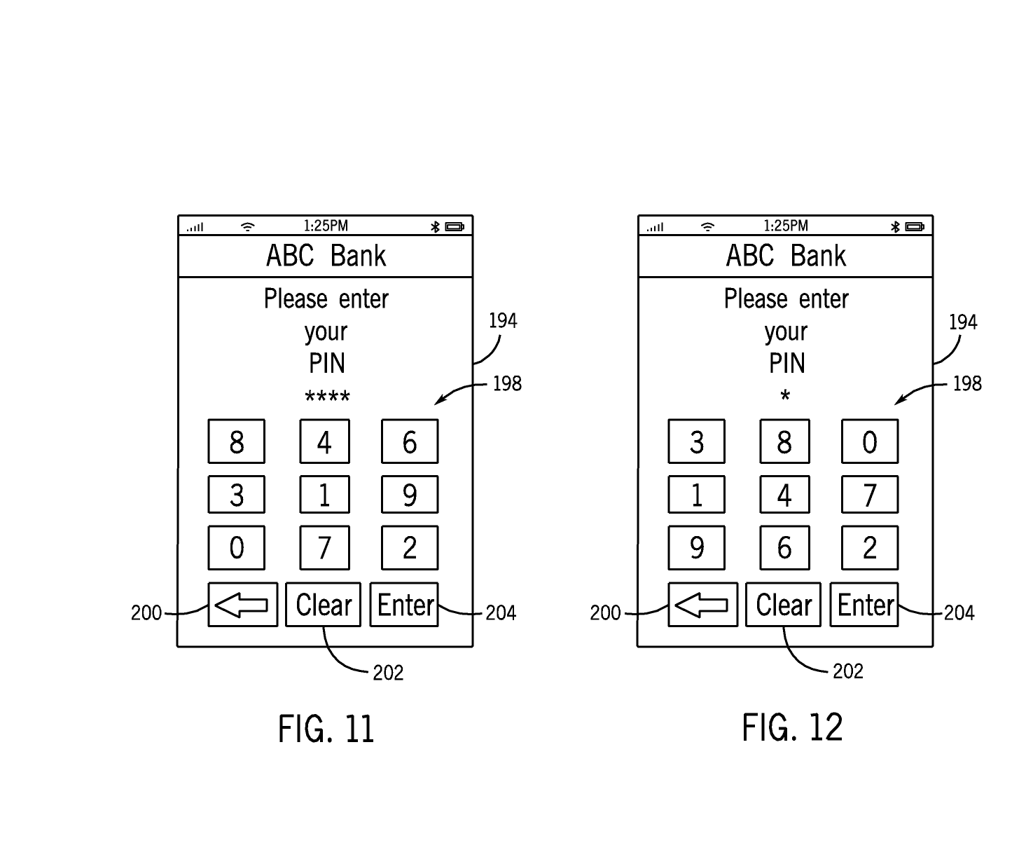

After the device 10 has been authenticated, the device 10 may list a number of accounts stored on the device 10 that may be used for the transaction. Specifically, as illustrated in FIG. 10, an accounts screen 190 may be displayed from which may include, for example, a listing 192 of multiple credit cards and bank cards that may be used for the transaction. The listing 192 may be prioritized in accordance with the teachings of the commonly assigned patent application filed Sep. 30, 2008, by Andrew Hodge, Michael Rosenblatt, and Amir M. Mikhak, entitled, “Smart Menu Options,” patent application Ser. No. 12/286,341 (Applicant docket number P6714US1/APPL:0054), which is incorporated herein in its entirety and, for all purposes, by reference. Additionally, the device 10 may be configured to determine, based on the context of the transaction, which account is to be used. The context may include the identity of the terminal and/or the location of the device 10, among other things. For example, if the device 10 determines that it is communicating with an ATM machine, the device 10 may automatically select the ABC bank debit card for the transaction.

Referring again to FIG. 7, an embodiment where the device 10 automatically selects a card for the transaction is illustrated. Specifically, after authentication of the device 10, as discussed above, the device 10 may automatically select a card, such as the ABC Bank card, for a transaction with the transaction terminal 130, which may be an ATM. The selection of a bank card may prompt a PIN entry screen 194, where the user may again be required to authenticate by providing a personal identification number (PIN) using a number pad 196 on the screen 180.

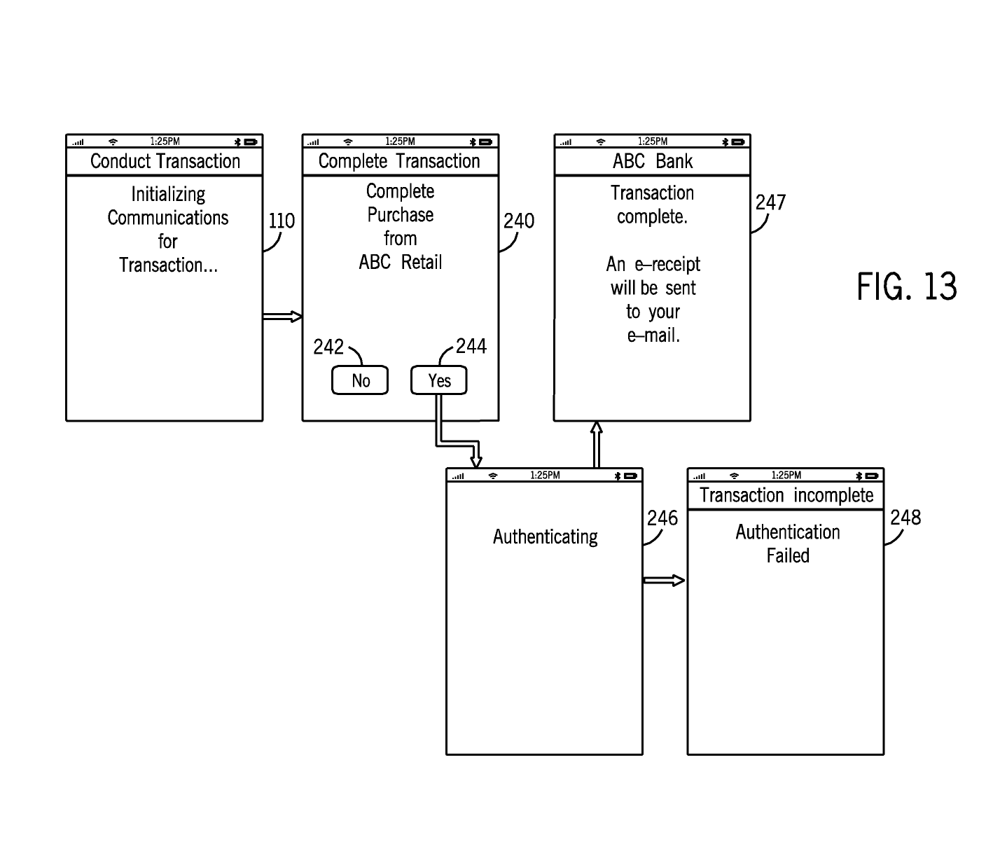

In some embodiments, the order of the numbering may be altered for the number pad 196. Specifically, as illustrated in FIG. 11, the number pad 198 may be randomly organized so that another person cannot tell what numbers are being pressed based on the location of where a user presses the screen 194. In some embodiments, as illustrated in FIG. 12, the ordering of the numbers on the number pad 198 may change after the entry of each digit. Specifically, for example after entry of the first digit the number pad 198 may scramble the numbers and repeat after each digit is entered. The number pad 194 may have a back space button 200, a clear button 202 and an enter button 204, each of which may be scrambled with the numbers.

In addition to changing the order after each number is entered or changing the order of the numbering in general, the tones associated with the numbers may be altered so that the number being pressed cannot be discerned based upon the tones associated with pressing the numbers. Additionally, in some embodiments, the tones may be associated with a particular location on the screen, such that, when the numbers are scrambled, a tone associated with a location is not associated with a number for which is traditionally associated but may give the impression that a particular digit conventionally associated with the location is being pressed.

Referring back to FIG. 7, once the PIN has been entered, the user may gain access to the account and may conduct a transaction with the terminal 130. As briefly mentioned above, the device 10 may display content associated with the transaction and may be used to conduct the transaction in lieu of a screen 134 of the terminal. As such, after authentication and entering a correct PIN, the device 10 may display a welcome screen 206 which may include a menu 208 of options for the user. Continuing with the ABC Bank example, the device 10 may display content from ABC Bank. For example, it may include options as to various types of transactions that may be conducted with ABC Bank including making withdrawals, making a deposit, checking a balance and transferring money.

Upon selection of the make a withdrawal option, a user may be brought to a withdrawal screen 220 which may display various amounts of cash for withdrawal. Additionally, a user may select an “other” button 222 and enter an amount other than those listed. If a user selects a cancel button 224 the user is returned to the welcome screen 206 to make a different selection as to the type of transaction to be conducted. Alternatively, if the user selects an amount and presses the continue button 226 the user may be brought to a transaction complete screen 228 that may indicate that the transaction has been completed and an e-receipt is being mailed to an email account associated with the account. Additionally, the terminal 130 may provide the user with the request amount of cash. The user may then select to conduct a new transaction by pressing the new transaction button 230 or, alternatively, finish and close out the transaction by pressing the done button 232.

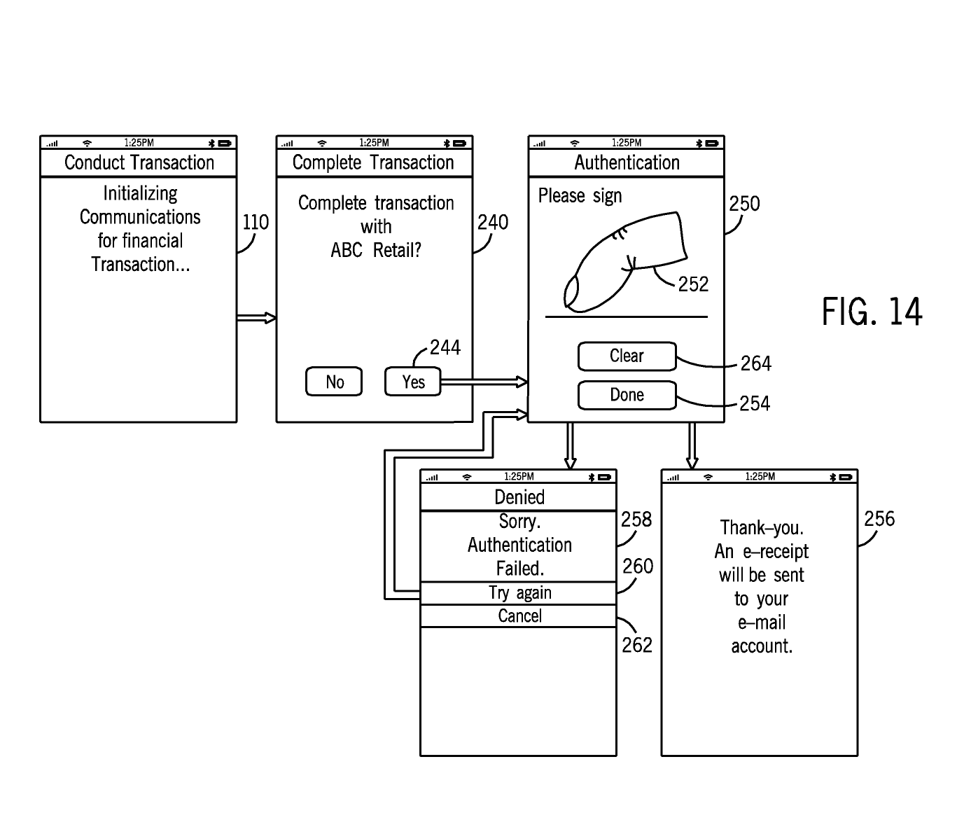

Referring now to FIG. 13, an alternative transaction path is described in accordance with an alternative embodiment. As discussed above, the device 10 may be configured to determine the context of the transaction including an identity of the terminal and/or the location of the device 10. For example, as discussed above, after selection of the conduct transactions button 106 (FIG. 4), the device 10 may initiate communications for the transaction. After the communications channels have been opened for the financial transaction, that is, after the device 10 has detected and opened up a communication channel with the terminal 130, the device 10 may be configured to automatically select an appropriate payment method as discussed above. Once the device 10 has selected an appropriate payment method, the user may be brought to complete transaction screen 240 at which point the user may indicate whether or not the transaction should be completed. The user may select a “no” button 242 to return to a main screen 29 or a yes button 244 to continue with the transaction.

If the user selects the yes button 244 the user may be brought to an authentication screen 246 wherein the device 10 is authenticated in accordance with at least one of the above described authentication techniques. If the device 10 is authenticated, a transaction completed screen 247 may be displayed. Alternatively, however, if the authentication fails, the device 10 may display a transaction incomplete screen 248 indicating that the authentication failed.

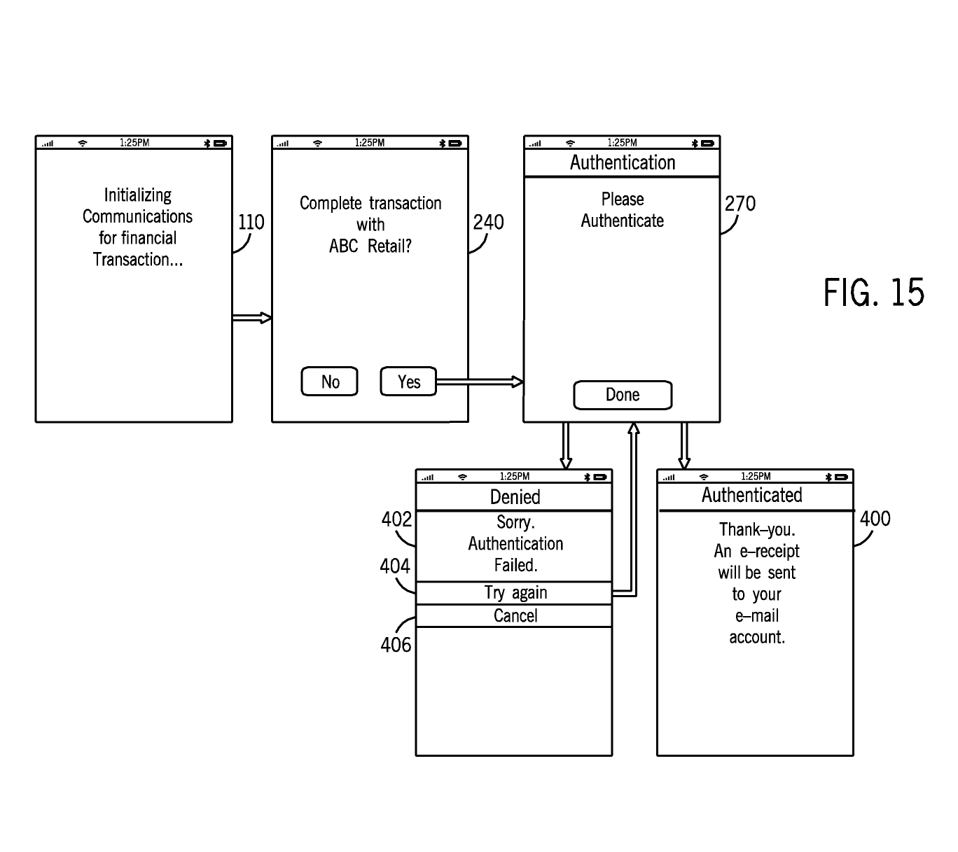

FIG. 14 illustrates other embodiments wherein after the device 10 has initialized communications as illustrated by screen 110 and the user has indicated on the transaction screen 240 a desire to continue with the transaction, as discussed previously with regard to FIG. 13. The user may be brought an authentication screen 250 wherein the user may be required to authenticate by providing a signature on the screen 26. The user may use a stylus or a finger 252, as illustrated, to provide a signature to authenticate the transaction. Once the user has entered the signature, the device 10 or the terminal 130 may be configured to analyze the signature using writing recognition software and/or by comparing the signature with a stored signature.

Specifically, for example, once the user selects the done button 254 the device 10 may compare the provided signature with a signature that has been previously stored for authentication purposes. If the signature coincides with the stored signature, the user may be brought to a receipt screen 256 which indicates that the transaction has been completed and a receipt has been sent to an email account associated with the account used in the transaction. Alternatively, if the signature does not coincide with the stored signature, the user may be brought to a denied screen 258 which indicates that the authentication failed. The user may then select to try again using the try again button 260 or, alternatively, cancel the transaction using the cancel button 262.

Upon selection of the try again button 260, the user may be returned to the authentication screen for re-entry of the signature. If the user inadvertently messes up the signature a clear button 264 is provided which clears the entered signature and allows the user to start over. After entry of the signature and selection of the done button 254, the device may again perform an analysis to authenticate the user. The device may be configured to only allow a several attempts to authenticate before the device locks and denies all attempts to complete the transaction for a set period of time.

Turning to FIG. 15, in other alternative embodiments, after indicating a desire to complete the transaction from the complete transaction screen 240, a user may be asked to authenticate the transaction by an authentication screen 270. The authentication screen 270 may be an open-ended screen allowing for multiple types of input to be used for the authentication. For example, a user may authenticate by providing a signature on the screen 270, by providing a voice signature, by using the device to sign a name in the air, or by moving the device 10 in a pattern, as discussed in detail below.

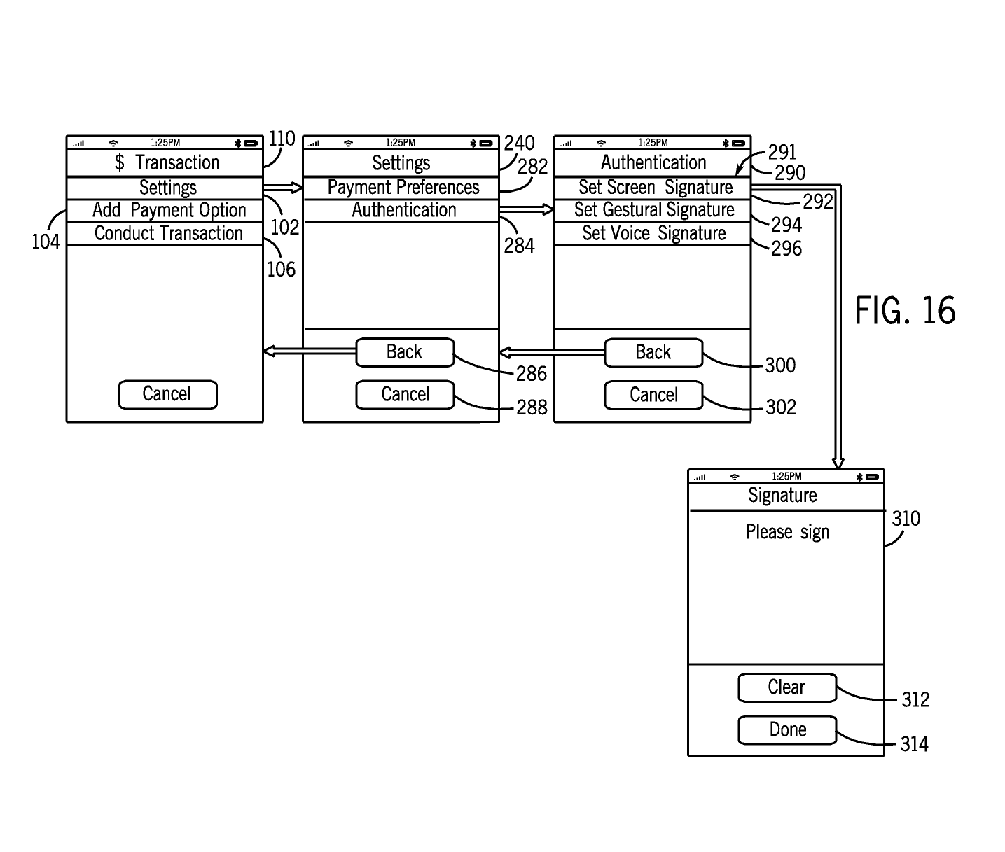

A user may set an authentication that satisfies the authentication request of the authentication screen 270 by selecting the settings button 102 of the transactions home page 100. As illustrated in FIG. 16, upon selection of the settings button 102 a user may be brought to a settings screen 280 from which the user may set payment preferences using the payment preferences button 282 or an authentication preferences using authentication button 284. The payment preferences may be set according to a variety of different ways described in great detail in the commonly assigned and previously incorporated patent application filed Sep. 30, 2008, by Andrew Hodge, Michael Rosenblatt, and Amir M. Mikhak, entitled “Smart Menu Options,” patent application Ser. No. 12/286,341 (Applicant docket number P6714US1/APPL:0054). Additionally, the user may select a back button 286 from the Settings screen 280 to return to the transactions home screen 100 or, alternatively, select a cancel button to return to the home screen 29.

With respect to authentication, the user may select the authentication button 284 upon which the user is brought to an authentication screen 290. The authentication screen 290 may allow the user to set authentication preferences to satisfy the authentication screen 270 of FIG. 15. As can be seen in FIG. 16, the authentication screen 290 provides a menu 291 that lists various ways for authenticating a transaction. For example, the user may authenticate using a screen signature, a gestural signature, a voice signature, among others, including biometric signatures such as fingerprints and retinal scans, for instance. The user may set a screen signature button 292, a gestural signature by selecting set gestural signature 294 button, or a voice signature using the select voice signature button 296. Alternatively, the user may select a back button 300 or a cancel button 302. The back button 300 returns a user back to the setting screen 280, while the cancel button 302 returns the user to a home screen 29.

Upon selection of the set screen signature button 292, a user may be prompted to enter a signature by the signature screen 310. The user may enter a signature directly on the screen on the line provided. If the user messes up, a user may clear the screen using the clear button 312. Alternatively, the user may save the signature by selecting the done button 314. As discussed above, this signature may be used for comparison when authenticating a transaction. Specifically, a statistical analysis may be performed by the device 10 to determine whether or not sufficient features of the stored signature are in common with the signature provided for authentication a transaction.

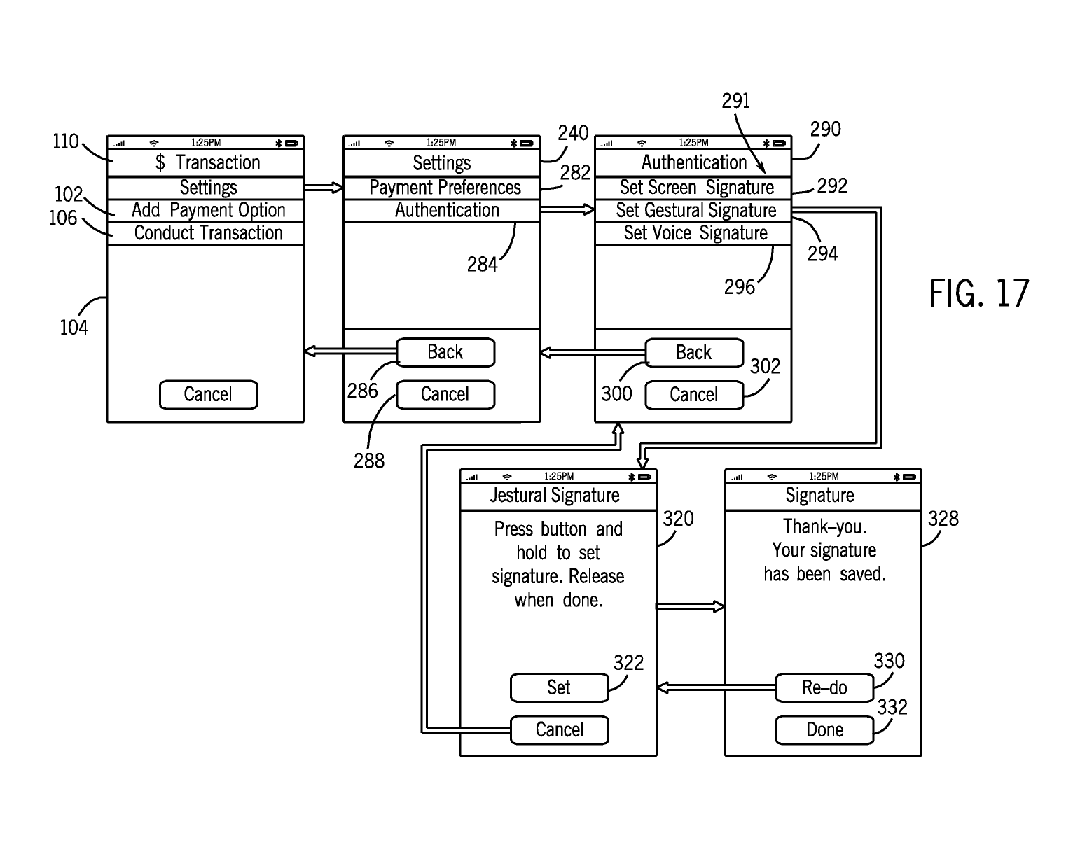

Alternatively, a user may select a set gestural signature button 294 to be brought to a gestural signature screen 320, as shown in FIG. 17. Upon selection of the set gestural signature button 294, a gestural signature screen 320 prompts the user to press and hold a set button 342 to set a signature. The user may then press the set button 342 and move the device 10 in any manner. While the set button 342 is depressed, the device 10 may be configured to record the movement of the device as detected by accelerometers 72 (FIG. 3) provided in the device 10. The movement may be stored by the device 10 and set as the gestural signature.

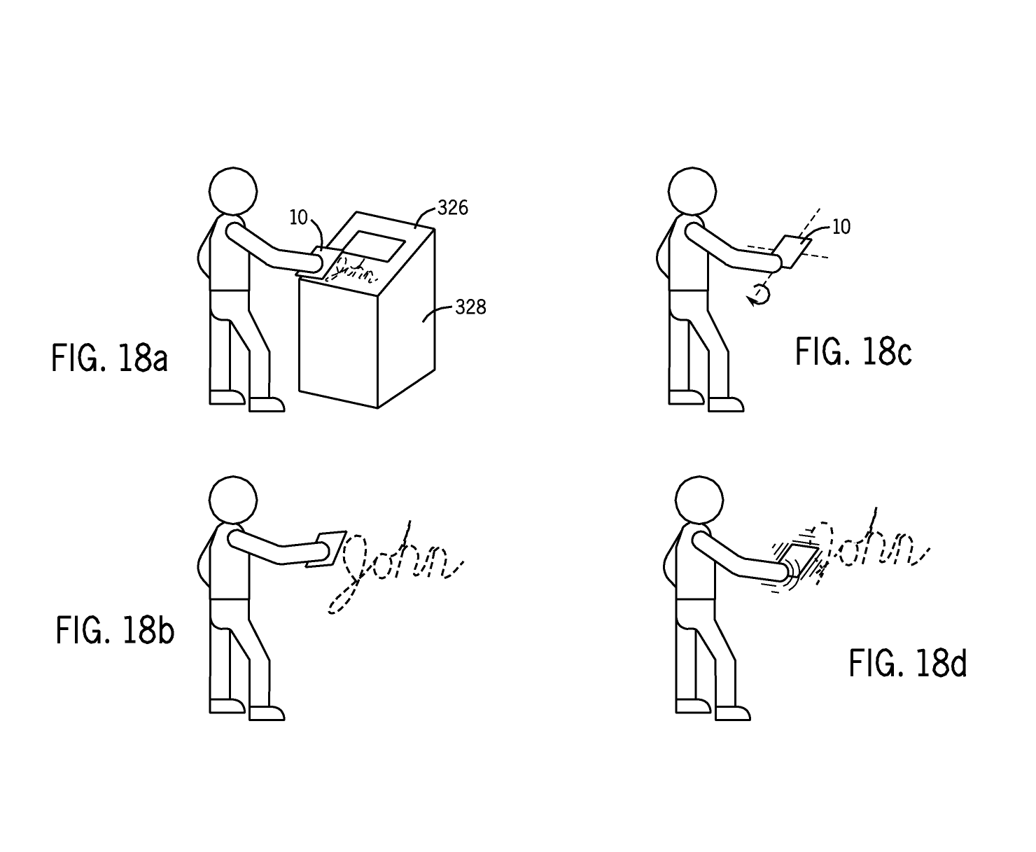

Referring to FIGS. 18A-18C, various types of gestural signatures may be provided by the user. For example, the user may use a corner of the device 10 and write on a surface, such a surface 326, of a terminal 328, as shown in FIG. 18a. Alternatively, as illustrated in FIG. 18b, the user may simply sign a name in the air by moving the device 10 to spell out a name in the air. As illustrated in FIG. 18c a pattern may be provided by a user by, for example, moving the device 10 to the left, to the right, up, down, and with a twist. Therefore, the signature may simply be a pattern set by the user and recognized by the device 10.

Alternatively, in some embodiments, the device 10 may be configured to authenticate a user based on sensing the amount of quiver provided by a user when the user is providing a signature. As illustrated in FIG. 18d, a user may provide a signature and the device may be configured to determine how much the user shakes while providing the signature using the device 10. When authenticating the device 10 may determine if a user shakes in a statistically significant manner more than what the device 10 detected when the user was setting the signature.

In yet another alternative embodiment, the device 10 may be configured to authenticate a user based solely on the amount of shaking detected when a user is providing a signature. Thus, the device 10 may authenticate a user independently from any baseline provided by a user while setting a gestural signature. Underlying this form of authentication is an assumption that one who has previously set a signature motion or who is familiar with the motion for the signature would provide a smooth motion relative to a motion provided by an individual who has not provided the signature before. That is, it is assumed that an individual that has previously signed a name may be more confident and have smoother muscle motion rather than one has not signed a name or performed a particular gestural signature.

After the user has set a gestural signature the device 10 may display a screen 328 indicating the signature has been saved. The user may then select to re-do the signature by pressing re-do button 330 or, alternatively, select the done button 332. Upon selection of the done button 332, the user has set the gestural signature and the gestural signature is stored for future authentication.

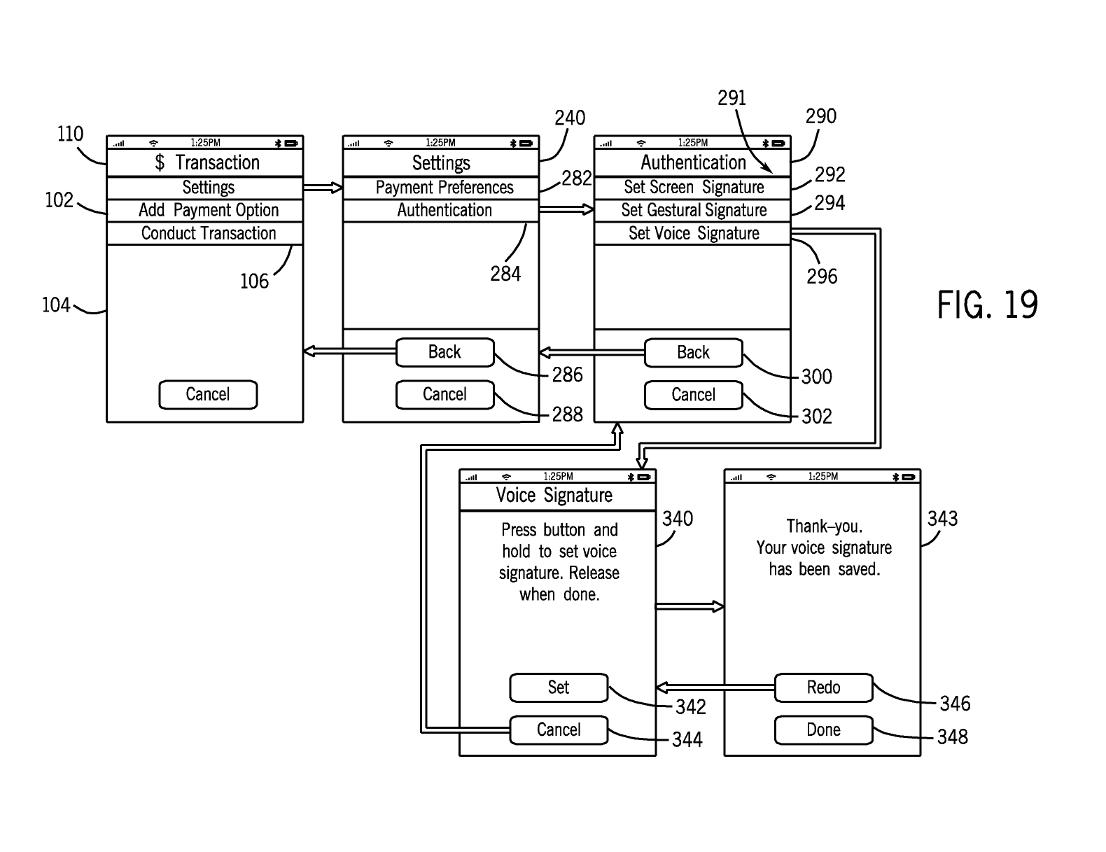

Referring now the FIG. 19, the user may set a voice signature by selecting the set voice signature button 296 from the authentication screen 290. Upon selection of the set voice selection button 296 a user may be prompted by a voice signature screen 340 to press a set button 342 and provide a voice sample. For example, the user may simply hold the set button 342 and state the user's name or, alternatively, make a statement that the user can remember. Thus, the user may use a favorite phrase or a password for the authentication. The device 10 saves the voice signature and may use the stored voice signature for future authentication. The user may return to the authentication screen 290 without setting a voice signature by pressing the cancel button 344.

Once the user has provided a voice sample, a screen 343 may indicate that the voice signature has been saved for future authentication purposes. The user may choose to re-do the voice signature by pressing the re-do button 346 or may complete the setting of the voice signature by selecting the done button 348. Other biometric signatures, such as fingerprints, retinal scans, etc., may be set in a similar manner except they may require that the device 10 include a device for detecting a finger print or a device for performing a retinal scan.

Returning again to FIG. 15, the device 10 may be configured to perform a statistical analysis to determine whether the provided screen signature, gestural signature or voice signature is sufficiently similar to the set authentication signature. If so the provided signature correlates with the saved signature, the user is authenticated and an authenticated screen 400 is displayed indicating an e-receipt may be emailed to the user's email account. Alternatively, if there is not sufficient correlation between the set signature and signature provided by the user, a denied screen 402 may be displayed, which indicates that the authentication failed. The user may select to try again by selecting the try again button 404 or alternatively may cancel the transaction all together by selecting the cancel button 406.

As discussed above, the various functions of the device 10 may be used to authenticate a user and/or the device 10 for transactions. In this regard, it will be understood that the functions of the device 10 and the various authentication techniques may also be used for advanced fraud detection by financial institutions. Specifically, for example, the techniques may be used to for advanced fraud pattern recognition on the server-side of the financial institutions. Currently, financial institutions, such as credit card companies, for example, may look for fraud based on transaction patterns by looking for incongruities in transaction histories for users. For example, if a particular account has been used in a single location (for example, Houston, Tex.) for the past 10 months and in one week was used for purchases in that location on Monday and Wednesday, but was also used for a transaction in a different location (such as New York City, for example) on Tuesday, the purchasing pattern may be used to flag the transaction on Tuesday for potential fraud. Similarly, if a user makes an online transaction with a credit card, but with a phone area code that does not match a billing zipcode region, and provides yet another shipping address, the transaction may be flagged for potential fraud. In these examples, the device 10 may be used to provide some of the information that may be useful to detect the fraudulent transactions.

In some embodiments, for example, a financial institution may log (i.e., store at a database, such as the database 164 in FIGS. 9a-b, for example) an authentication method used for each transaction and the location of the device 10 when each transaction occurs, along with other information related to the transaction. An example a log entry for a particular transaction may have a general form: <transaction datetime=9/26/08><vendor=BestBuy><transaction dollar amount=$249.78><Transaction terminal ID=12345><user location 40.45374, −80.180283><location predicted accuracy+45 meters><user primary authentication method=NFC><user secondary authentication method=accelerometer signature><transaction status+confirmed, completed>. As can be seen, the transaction log may include location information that may be provided from the positioning device 70, as well as authentication information used to complete the transaction, including primary and secondary authentication methods. Some of the information pertinent to the detection of fraud may be provided by the device 10 and collected for analysis by the financial institutions. If the transaction log indicates an incongruity with respect to previously logged transactions, the transaction may be flagged for potential fraud.

Moreover, in some embodiments, the authentication patterns may be used for fraud detection. For example, if a particular user historically only used a particular authentication method but for one or several transactions used a different authentication technique, the one or several transactions may be flagged as potentially fraudulent transactions. In some embodiments, the authentication patterns may be used in combination with other patterns for fraud detection. For example, if a user typically used signature to authenticate, but one day a transaction occurs in a location where the user has never conducted a transaction previously and the transaction was completed using a PIN which has never previously been used to authenticate a transaction, the financial institution may use such a pattern incongruity to flag the transaction as potentially being fraudulent.

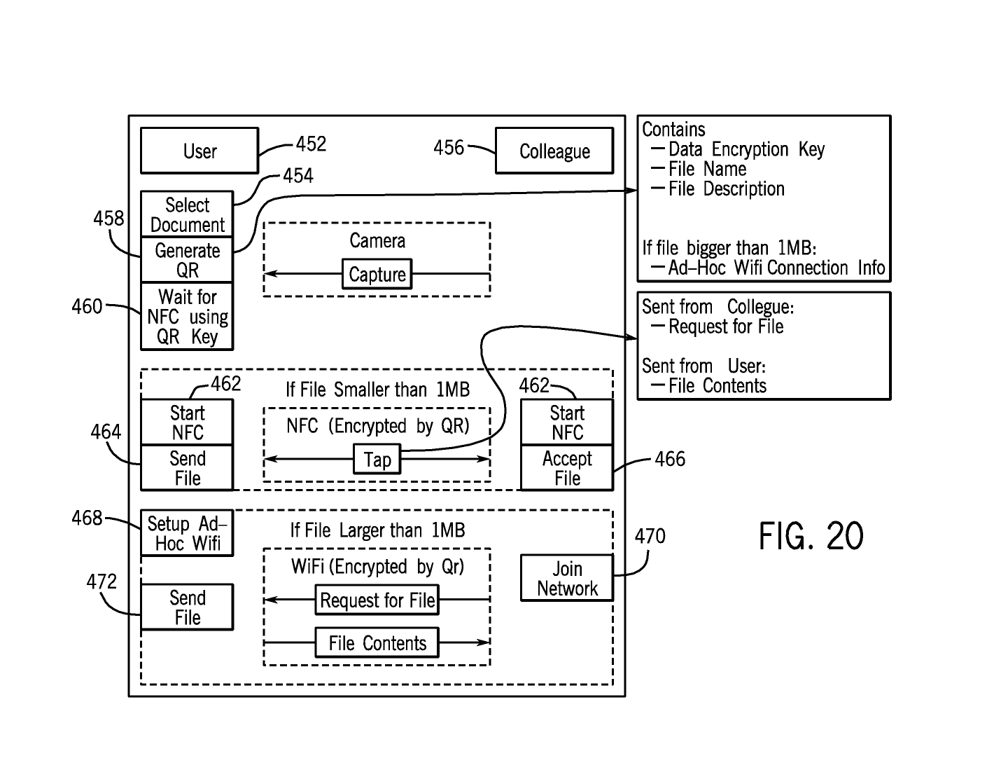

In addition to using the features of the device 10 in the above mentioned techniques, the security features discussed herein may be used for transactions and/or communications between the device 10 and other similarly configured devices. For example, a user of the device 10 may want to share a document with a colleague. FIG. 20 is a block flow diagram 450 illustrating a file transfer transaction between two devices in accordance with an embodiment. In discussing the block flow diagram reference numerals are used to refer to blocks and the user 452 and the colleague 456 may refer to the user, the colleague and their respective devices. As illustrated, a user 452 may select a document 454 to share with a colleague 456 the device 10 may be configured to generate a code 458 with information related to the file transfer transaction. For example, the code 458 may contain an encryption key, a file name, and a file description, among other things.

The colleague 456 may then capture the code 458 using a camera, a scanner or other device, as discussed above. The user 452 then waits for short range wireless communications using the encryption key 460. A short range wireless communication channel may then be opened by the colleague sending a request for the file encrypted by the encryption key via a short range wireless communication protocol 462, such as NFC, for example. Because of bandwidth and range limitations of the NFC protocol, the file being transferred or shared should be less than 1 MB and the two devices should be within two to four centimeters from each other. If the file is less than 1 MB the file is sent 464 from the user 452 using the short range wireless communication protocol and the colleague 456 may accept the file 466

As illustrated, however, if the file is larger than 1 MB an ad-hoc Wi-Fi connection 468 may be created to transfer the file. Specifically, the request for the file may be transmitted via NFC communications, but the file may be transferred via Wi-Fi. To set up the Wi-Fi connection, the colleague 456 may join the user's network 470. Once the colleague 456 and the user 452 are on the same network, the user 452 may send the file to the colleague 472.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for conducting a financial transaction comprising:
taking a picture of a first code displayed on a transaction terminal using a camera of a portable electronic device; and
sending data from the portable electronic device to the transaction terminal to conduct the financial transaction with the transaction terminal using a near field communication channel or another wireless communication channel, or both, wherein the data is derived from the first code to enable the transaction terminal to verify that the portable electronic device is physically located near the transaction terminal.

2. The method of claim 1, comprising taking a picture of a second code displayed on the transaction terminal using the camera of the portable electronic device and sending data derived from the second code from the portable electronic device to the transaction terminal to conduct the financial transaction with the transaction terminal, wherein the second code replaces the first code displayed on the transaction terminal after a period of time.

3. The method of claim 1, comprising sending a location of the portable electronic device to the transaction terminal to aid the transaction terminal in verifying that the portable electronic device is physically located near the transaction terminal.

4. The method of claim 3, wherein the location of the portable electronic device is determined by the portable electronic device communicating with one or more cellular towers.

5. A method for conducting a financial transaction comprising:
generating a code to be used by the transaction terminal to verify that the portable electronic device is physically located near the transaction terminal;
displaying the code on a display of the transaction terminal;
receiving data from the portable electronic device via a near field communication channel or another wireless communication channel, or both, wherein the data comprises decoded information from the code and indicates to the transaction terminal that the portable electronic device is physically located near the transaction terminal; and
allowing the portable electronic device to conduct the financial transaction with the transaction terminal while the data indicates that the portable electronic device is physically located near the transaction terminal.

6. The method of claim 5, wherein more than one code is generated, the method further comprising intermittently changing the code on the display.

7. The method of claim 5, wherein allowing the portable electronic device to conduct the financial transaction with the transaction terminal using data based on the code comprises comparing the data from the transaction terminal with the generated code.

8. The method of claim 5, wherein allowing the portable electronic device to conduct the financial transaction with the transaction terminal comprises receiving a location of the portable electronic device from the portable electronic device and comparing the location of the portable electronic device with a location of the transaction terminal.

9. A method for authenticating a portable electronic device used in a financial transaction comprising:
initiating short range wireless communication between the portable electronic device and a transaction terminal;
determining a location of the portable electronic device using the portable electronic device;
providing the location of the portable electronic device to the transaction terminal using the short range wireless communication to allow the transaction terminal to compare the location of the portable electronic device with a location of a transaction terminal and authenticate the portable electronic device if the location of the portable electronic device corresponds with the location of the terminal; and
receiving an indication of authentication of the portable electronic device from the transaction terminal using the short range wireless communication to allow the portable electronic device to complete a financial transaction with the transaction terminal.

10. The method of claim 9, wherein a global positioning device determines the location of the portable electronic device.

11. The method of claim 9, wherein determining the location of the portable electronic device comprises using a cellular network.

12. The method of claim 9, wherein determining the location of the portable electronic device comprises using a Wi-Fi network.

13. The method of claim 9, wherein determining the location of the portable electronic device comprises using Bluetooth communication.

14. A method for conducting a financial transaction comprising:
generating a code at a transaction terminal;
displaying the code on a display of the transaction terminal;
receiving a request to conduct the financial transaction, wherein the request comprises a communication derived from the code to enable the transaction terminal to verify that the request was received from a device physically located near the transaction terminal; and
opening a communication channel to complete the financial transaction after the request is received.

15. The method of claim 14, wherein the generated code comprises an encryption key and the request for conducting the financial transaction is encrypted using the encryption key.

16. The method of claim 14, wherein the code comprises a file name.

17. The method of claim 14, wherein the code comprises a QR code.

18. The method of claim 14, wherein opening a communication channel comprises opening a near field communication channel.

19. The method of claim 14, comprising setting up an ad-hoc Wi-Fi network for completion of the financial transaction.

20. The method of claim 14, wherein more than one code is generated, the method comprising changing the code intermittently.

21. The method of claim 1, wherein the code comprises a QR code.
